(19) United States
(12) Patent Application Publication
(10) Pub. No.: US 2007/0273803 A1
(43) Pub. Date: Nov. 29, 2007

(54) ACTIVE COMPONENT ARRAY SUBSTRATE AND FABRICATING METHOD THEREOF

(76) Inventors: Meng-Chi Liou, Taoyuan County (TW); Yu-Liang Wen, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,908

(22) Filed: May 25, 2006

(51) Int. Cl. G02F 1/136

(52) U.S. Cl. 349/43

(57) ABSTRACT

A fabricating method of an active component array substrate is provided. A substrate is provided and scan lines, data lines, active components, common lines, a first dielectric layer, and a second dielectric layer are formed. Each of the active components is controlled by the scan line and the data line. The first dielectric layer extends from each active component to above pixel regions and the second dielectric layer covers the substrate. A half tone mask is used to remove a part of the second dielectric layer, such that contact windows are formed and a recess is formed above the common line on a part of each pixel region. A pixel electrode is formed above each of the pixel regions and coupled to the common lines to form a storage capacitor.

### BACKGROUND OF THE INVENTION

1. Field of the Invention

The present invention relates to a component array substrate and a fabricating method thereof. More particularly, the present invention relates to an active component array substrate and a fabricating method thereof.

2. Description of Related Art

The thin film transistor liquid crystal display (TFT-LCD) mainly comprises a thin film transistor array substrate, a color filter array substrate, and a liquid crystal layer. The thin film transistor array substrate comprises a plurality of thin film transistors in arrays and pixel electrodes arranged corresponding to each of the thin film transistors. The thin film transistors are used as switches of the liquid crystal display unit. Furthermore, in order to control an individual pixel unit, a specific pixel is selected by the scan lines and the data lines, and an appropriate operating voltage is applied to display the display data corresponding to the specific pixel. Moreover, a part of the area of the pixel electrode described above generally covers the scan lines or the common lines to form a storage capacitor. In conventional arts, common storage capacitors are classified into two architectures, namely metal-insulator-metal (MIM) and metal-insulator-ITO (MII). The structures of the two architectures of storage capacitors will be described in detail below.

FIG. 1 is a schematic sectional view of a storage capacitor of the conventional MIM architecture. Referring to FIG. 1, in a conventional pixel structure, a storage capacitance value Cst of MIM architecture is usually formed through the coupling of a scan line or common line 100 and an upper electrode 120 thereon. It should be noted that in the storage capacitor of MIM architecture, the scan line or common line 100 and the upper electrode 120 are electrically insulated by a gate insulation layer 110, so the storage capacitance value Cst corresponds the thickness of the gate insulation layer 110. In other words, the less the thickness of the gate insulation layer 110 is, the greater the storage capacitance value Cst will be. In addition, a pixel electrode 140 is electrically connected to the upper electrode 120 through a contact window 132 in a protection layer 130.

FIG. 2 is a schematic sectional view of a storage capacitor of the conventional MII architecture. Referring to FIG. 2, in the conventional pixel structure, a storage capacitor of MII architecture is usually formed through the coupling of a scan line or common line 200 and a pixel electrode 230 thereon. Unlike the MIM architecture, the scan line or common line 200 and the pixel electrode 230 in the storage capacitor of MII architecture are electrically insulated by a gate insulation layer 210 and a protection layer 220, so that the storage capacitance value Cst corresponds the total thickness of the gate insulation layer 210 and the protection layer 220. In other words, the less the total thickness of the gate insulation layer 210 and the protection layer 220 is, the greater the storage capacitance value Cst will be.

With the increase of the panel size, voltage waveform delay and distortion often occur in signals transmitted through scan lines due to an RC effect. In this case, a part of the pixel electrodes receives wrong data signals due to insufficient charge or feed-through voltage, so nonuniform brightness and flickers occur on two sides of the image. Therefore, the storage capacitance value Cst has to be adjusted to resolve the problems described above. However, in conventional thin film transistor array substrates, in order to increase the storage capacitance value Cst without affecting the aperture ratio, the total thickness of the gate insulation layer 210 and/or the protection layer 220 must be directly reduced. Particularly, if the total thickness of the gate insulation layer 210 and/or the protection layer 220 is directly reduced, the component reliability of the thin film transistors may be degraded.

### SUMMARY OF THE INVENTION

Accordingly, an object of the present invention is to provide a method for fabricating an active component array substrate, wherein an active component array substrate with more than two types of storage capacitors may be formed.

Another object of the present invention is to provide an active component array substrate having more than two types of storage capacitors.

In order to achieve the aforementioned and or other objects, the present invention provides a method for fabricating an active component array substrate. First, a substrate is provided. A plurality of scan lines, a plurality of data lines, a plurality of active components, a plurality of common lines, a first dielectric layer, and a second dielectric layer are formed on the substrate, wherein the scan lines and the data lines define a plurality of pixel regions on the substrate, and the common lines are arranged on the substrate. Each of the active components is respectively controlled by corresponding scan line and data line. The first dielectric layer extends from each active component to above the pixel regions, and the second dielectric region covers the scan lines, the data lines, the common lines, the active components, and the first dielectric layer. Next, a half tone mask is provided to remove a portion of the second dielectric layer, such that a plurality of contact windows is formed. A recess is formed above the common line on a portion of each pixel region. Then, a pixel electrode is formed on each pixel region. The pixel electrode is coupled to the common line to form a storage capacitor. Each of the pixel electrodes is electrically connected to the active components via corresponding contact windows. The storage capacitors are classified into more than two types.

In one embodiment of the present invention, the overlapping areas of the recess and the common lines above each pixel region is gradually reduced from one end of the common lines to the other end.

In one embodiment of the present invention, each of the common lines has a plurality of branches extending outward from the edges of two sides and being parallel to the data lines.

In one embodiment of the present invention, the step of forming the contact windows and recesses includes forming a patterned photoresist layer on the second dielectric layer by using a half tone mask; removing a portion of the second dielectric to form the contact windows and the recesses above a portion of the common lines using the patterned photoresist layer as the mask; and removing the patterned photoresist layer.

In one embodiment of the present invention, the step of forming the recesses described above includes removing a portion of the thickness of the second dielectric layer above a portion of the common lines.

In one embodiment of the present invention, the step of forming the recesses described above includes completely removing the second dielectric layer above a portion of the common lines.

In one embodiment of the present invention, the step of forming the recesses described above includes completely removing the second dielectric layer above a portion of the common lines and removing a portion of the thickness of the first dielectric layer.

In order to achieve the aforementioned and or other objects, the present invention provides an active component array substrate fabricated using the method described above. The active component array substrate comprises a substrate, a plurality of scan lines, a plurality of active components, a plurality of pixel electrodes, a first dielectric layer, and a second dielectric layer. The scan lines, the data lines, and the common lines are arranged on the substrate, and the scan lines and the data lines define a plurality of pixel regions on the substrate. Furthermore, the common lines and the scan lines are alternately arranged on the substrate. The active components are respectively arranged on the pixel regions. Each of the active components is controlled by corresponding scan line and data line. The pixel electrodes are respectively arranged on the pixel regions. Each of the pixel electrodes is electrically connected to corresponding active components, and is coupled to the corresponding common line to form a storage capacitor. The first dielectric layer extends from each component to below the pixel electrodes. The second dielectric layer covers the active components, and extends from above the active components to below the pixel electrodes. The second dielectric layer has a plurality of recesses located above a part of the common lines. Moreover, the storage capacitors described above are classified into more than two types, and the minimum distance between each recess and the common lines is less than the total thickness of the first dielectric layer and the second dielectric layer in corresponding active components.

In one embodiment of the present invention, the overlapping areas of the recess and the common lines above each pixel region is gradually reduced from one end of the common lines to the other end.

In one embodiment of the present invention, each of the common lines has a plurality of branches extending outward from the edges of two sides and are arranged parallel to the data lines.

In one embodiment of the present invention, the minimum distance between the recesses and the common lines is greater than the thickness of the first dielectric layer in the active components.

In one embodiment of the present invention, the minimum distance between the recesses and the common lines is equal to the thickness of the first dielectric layer in the active components.

In one embodiment of the present invention, the minimum distance between the recesses and the common lines is less than the thickness of the first dielectric layer in the active components.

Accordingly, the present invention employs the half tone mask to simultaneously form the contact windows and the recesses. Therefore, more than two types of storage capacitors are formed on the same substrate by adjusting the depth of the recesses or the overlapping areas of the recesses and the pixel electrodes, such that the RC delay effect of large-size panels is reduced or eliminated.

In order to make aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

FIG. 1 is a schematic sectional view of a storage capacitor of a conventional MIM architecture.

FIG. 2 is a schematic sectional view of a storage capacitor of the conventional MII architecture.

FIGS. 3A-3I are schematic sectional views illustrating a method for fabricating an active component array substrate according to a first preferred embodiment of the present invention.

FIG. 4 is a schematic top view of the active component array substrate according to the first preferred embodiment of the present invention.

FIG. 5 is a schematic view of the active component array substrate according to a second embodiment of the present invention.

FIG. 6 is a schematic view of the active component array substrate according to a third embodiment of the present invention.

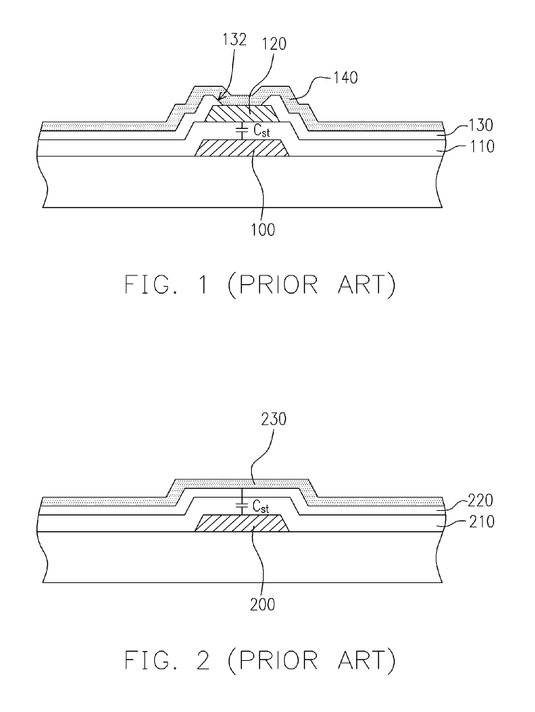

### DESCRIPTION OF EMBODIMENTS

The present invention employs a half tone mask to simultaneously form the contact windows and the recesses. Since the pixel electrodes cover the recesses, storage capacitors are formed by coupling the pixel electrodes and the common lines. More than two types of storage capacitors are formed on the same substrate by adjusting the depth of the recesses or the overlapping areas of the recesses and the pixel electrodes. Therefore, according to the present invention, the electrical performance of a large-size active component array substrates can be improved. Several embodiments will be described below to illustrate the present invention, which are not intended to limit the present invention. Those skilled in the art can make appropriate modifications to the following embodiments without departing from the spirit of the present invention, and such modifications are construed to be within the scope of the present invention.

### The First Embodiment

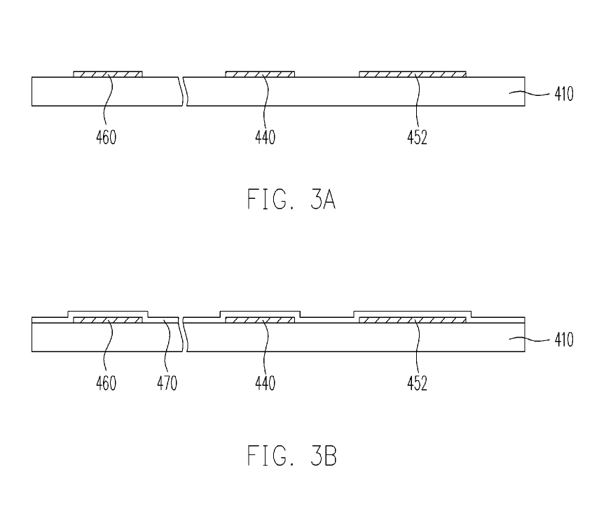

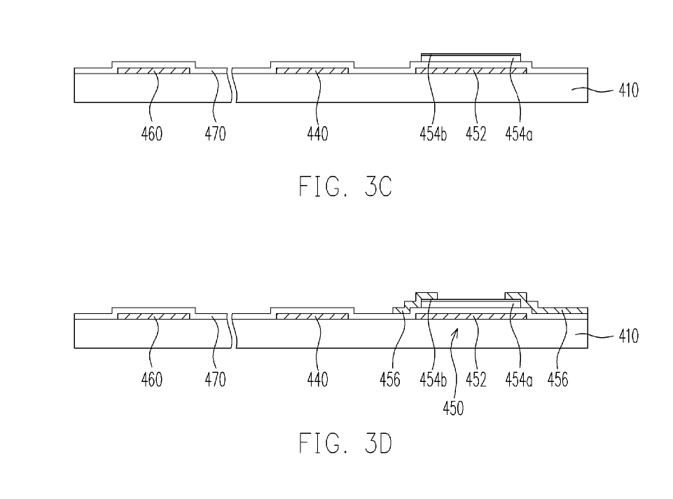

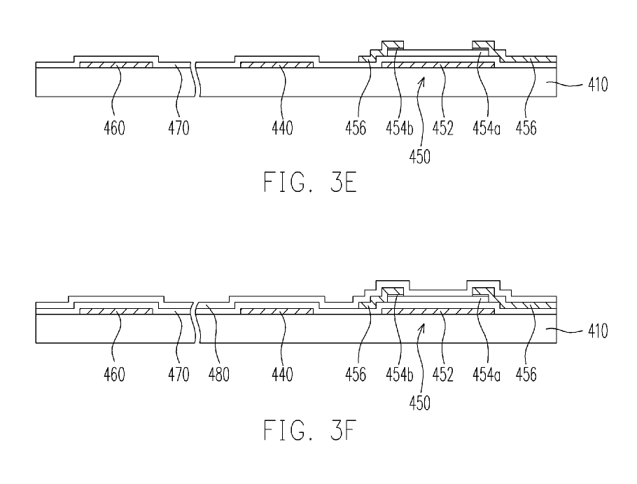

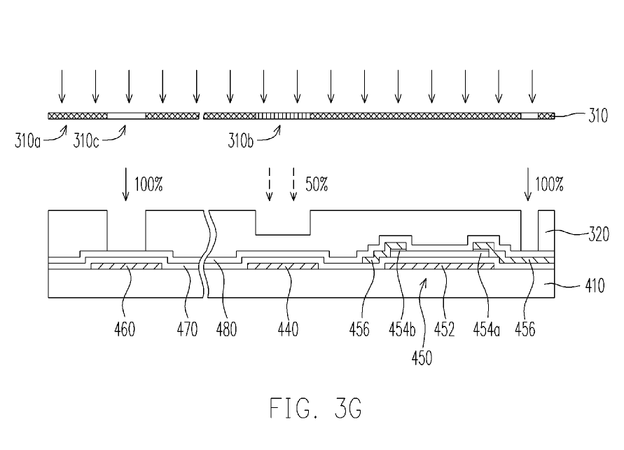

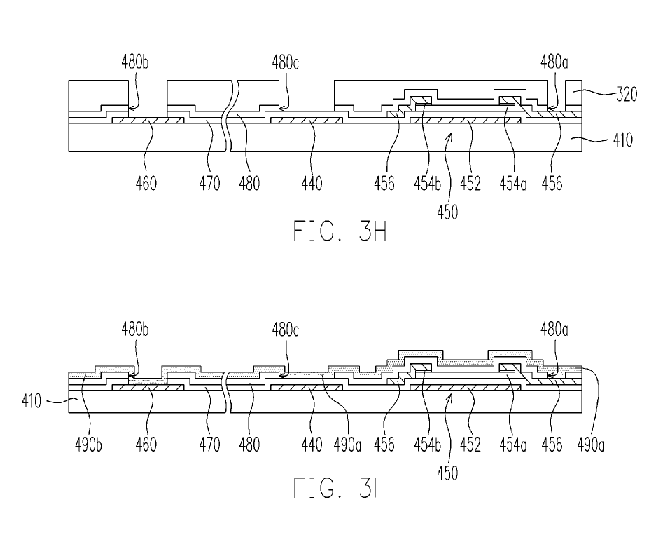

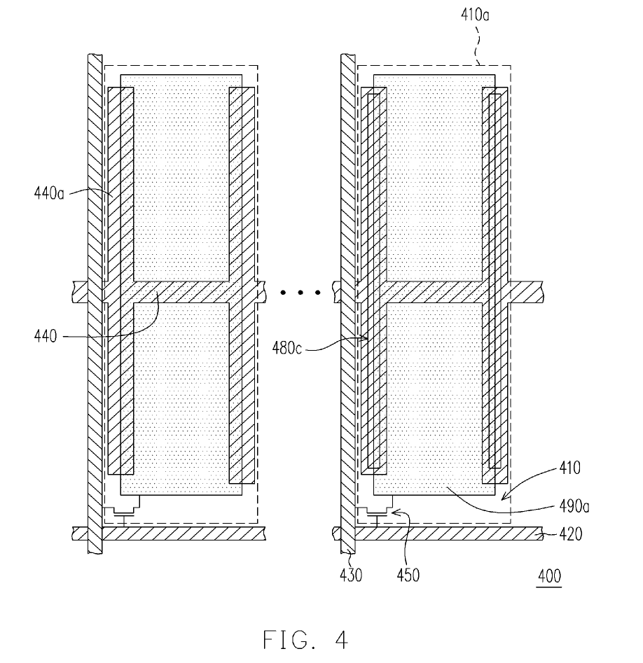

FIGS. 3A-3I are schematic sectional views illustrating a method for fabricating the active component array substrate according to the first preferred embodiment of the present invention. Referring to FIG. 3A, the method for fabricating the active component array substrate of the present invention comprises first forming a plurality of scan lines 420 (as shown in FIG. 4), a plurality of gates 452, a plurality of common lines 440, and a plurality of pads 460 on the substrate 410. Each of the scan lines 420 is connected between the pad 460 and the gates 452, and the pads 460 are electrically connected to the driving chip (not shown). Furthermore, for example, the scan lines 420, the gates 452, the common lines 440, and the pads 460 are formed simultaneously. For instance, the step of forming the scan lines 420, the gates 452, the common lines 440, and the pads 460 includes, for example, first forming a conductive material layer (not shown) on the substrate 410 with a sputtering process or physics vapor deposition (PVD) process. The material of the conductive material layer is, for example, Cr, Al, Al alloy, or other suitable materials. Next, a patterning process (including a lithography process and an etching process) is performed to pattern the conductive material layer to form the scan lines 420, the gates 452, the common lines 440, and the pads 460. Furthermore, the substrate 410 is, for example, a glass substrate, a plastic substrate, or a substrate made of other suitable material.

Referring to FIG. 3B, a first dielectric layer 470 is formed on the substrate 410, wherein the first dielectric layer 470 covers the scan lines 420, the gates 452, the common lines 440, and the pads 460. Moreover, the process for forming the first dielectric layer 470 includes, for example, a chemical vapor deposition (CVD) or a plasma enhanced CVD (PECVD). In addition, the material of the first dielectric layer 470 includes, for example, silicon oxide, silicon nitride, or other dielectric materials.

Referring to FIG. 3C, a semiconductor material layer (not shown) and an ohm contact material layer (not shown) are sequentially formed on the first dielectric layer 470. Next, the patterning process (including the lithographic process and the etching process) is performed to pattern the semiconductor material layer and the ohm contact material layer to form a semiconductor layer 454a and an ohm contact layer 454b. In addition, the material of the semiconductor layer 454a includes, for example, amorphous silicon, and the material of the ohm contact material layer 454b includes, for example, n-type doped amorphous silicon.

Referring to FIG. 3D, a plurality of sources/drains 456 and a plurality of data lines 430 (as shown in FIG. 4) are formed on the substrate 410. The sources/drains 456 are disposed on the ohm contact layer 454b and are electrically connected to the data lines 430. More specifically, the step of forming the sources/drains 456 and the data lines 430 includes, for example, forming a conductive material layer (not shown) on the substrate 410 using a sputtering process or the PVD process; and performing a patterning process to pattern the conductive material layer to form the sources/drains 456 and the data lines 430. The material of the sources/drains 456 and the data lines includes, for example, Cr, Al, Al alloy, or other suitable conductive material.

Referring to FIG. 3E, a portion of the ohmic contact layer 454b is removed using the sources/drains 456 as the mask. For example, an etch back process may be employed to remove a portion of the ohmic contact layer 454b. Thus, the fabrication of the active components 450 is completed.

Referring to FIG. 3F, a second dielectric layer 480 is formed on the substrate 410 to cover the sources/drains 456, the data lines 430, and the pads 460. For example, the second dielectric layer 480 may be formed by using, for example, a CVD or a PECVD process. In addition, the material of the second dielectric layer 480 includes, for example, silicon oxide, silicon nitride, or other suitable dielectric materials.

It should be noted that only three masks are used to form the structure shown in FIG. 3f in the embodiment, however the number of masks required to form the structure as shown in FIG. 3F is not limited in the present invention.

Referring to FIG. 3G, a half tone mask 310 is used to form a patterned photoresist layer 320 on the second dielectric layer 480. More specifically, the step of forming the patterned photoresist layer 320 includes, for example, forming a photoresist material layer (not shown) on the substrate 410; and exposing and developing the photoresist material layer to form the patterned photoresist layer 320.

As the half tone mask 310 comprises a non-transmissive area 310a, a partially transmissive area 310b and a completely transmissive area 310c, the transmittance of the partially transmissive area 310b is between that of the non-transmissive area 310a and the completely transmissive area 310c, so the thickness of the patterned photoresist layer 320 on various areas is different from one another. For example, the patterned photoresist layer 320 exposes a portion of the surface of the second dielectric layer 480 on the sources/drains 456 and a portion of the surface of the second dielectric layer 480 on the pads 460.

It should be noted that as the position of the partially transmissive area 310b corresponds to the common lines 440, the thickness of the patterned photoresist layer 320 above the common lines 440 is less than that of other portions of the patterned photoresist layer 320. In addition, the half tone mask 310 of the embodiment may also include a transmittance modulation mask or other suitable type of mask for forming a patterned photoresist layer with different thickness (as shown in FIG. 3G).

Referring to FIG. 3H, the etching process is performed using the patterned photoresist layer 320 as the mask until recesses 480c, and contact windows 480a and 480b are formed. At this time, the contact window 480a exposes a part of the surface of the sources/drains 456, and the contact window 480b exposes a part of the surface of the pad 460, in which the pad 460 functions as an etching stop layer. In addition, the recesses 480c are formed above the common lines 440. In the embodiment, a first dielectric layer 470 is disposed above the common lines 440. It should be noted that whether or not the recesses 480c are formed above all common lines is not limited in the embodiment. The areas and depths of all recesses 480c are not limited to be identical.

Referring to FIG. 3I, after the patterned photoresist layer 320 is removed, pixel electrodes 490a and a transparent conductive layer 490b are formed on the substrate 410. The pixel electrodes 490a are electrically connected to the sources/drains 456 via the contact window 480a, and the pixel electrodes 490a are coupled to the common lines 440. Thus, a storage capacitor formed. In addition, the transparent conductive layer 490b is electrically connected to the pads 460 via the contact window 480b.

As described in the above processes, the depths of the recesses 480c are determined by the thickness of the patterned photoresist layer 320 above the common lines 440. In addition, the depths of the recesses 480c or the overlapping areas of the recesses 480c and the pixel electrodes 490a result in different storage capacitors. In other words, the active component array substrate fabricated according to the embodiment can comprise more than two types of storage capacitors.

FIG. 4 is a schematic top view of the active component array substrate according to the first preferred embodiment of the present invention. Referring to FIGS. 4 and 3I, an active component array substrate 400 comprises a substrate 410, a plurality of scan lines 430, a plurality of active components 440, a plurality of pixel electrodes 490a, a first dielectric layer 470, and a second dielectric layer 480. The scan lines 420, the data lines 430, and the common lines 440 are arranged on the substrate 410. The scan lines 420 and the data lines 430 define a plurality of pixel regions 410a on the substrate 410. Furthermore, the common lines 440 are arranged substantially parallel to the scan lines 420. The common lines 440 and the scan lines 420 are alternately arranged on the substrate 410. In the embodiment of the present invention, each of the common lines 440 has a plurality of branches 440a extending outward from the edges on two sides and are substantially parallel to the data lines 430. However, the common lines 440 are not limited to have the branches 440a in the present invention. The active components 450 are respectively arranged on the pixel regions 410a, and each of the active components 450 is controlled by corresponding scan line 420 and data line 430. In addition, even though the embodiment is illustrated using the active components 450 including thin film transistors, the active components 450 are not limited thereto.

The pixel electrodes 490a are respectively arranged on the pixel regions 410a. Each of the pixel electrodes 490a is electrically connected to corresponding active component 450 via the contact window 480a. And, each of the pixel electrodes 490a is coupled to its corresponding common line 440 to form a storage capacitor. Furthermore, the first dielectric layer 470 extends from each component 450 to below the pixel electrodes 490a. The second dielectric layer 480 covers the active components 450, and extends from above the active components 450 to below the pixel electrodes 490a. The second dielectric layer 480 has a plurality of recesses 480c located above a part of the common lines 440. In the embodiment, all storage capacitors are divided into at least two types. In addition, the minimum distance between various recesses 480c and the common lines 440 is less than the total thickness of the first dielectric layer 470 and the second dielectric layer 480.

It should be noted that when the overlapping areas of the recesses 480c and the pixel electrodes 490a above each pixel region 410a vary, the capacitance of the storage capacitors on each pixel region 410a changes accordingly. Therefore, when the size of the active component array substrate 400 becomes larger, the capacitance of the storage capacitors on various pixel regions 410a gradually becomes high from the signal input end of the scan lines 420 to the other end, thus reducing or eliminating the RC delay effect. In other words, the overlapping areas of the recesses 480c and the common lines 440 above each pixel region 410a are gradually reduced from one end of the common lines 440 to the other end. However, the storage capacitors on various pixel regions can be distributed in other forms to reduce or eliminate the RC delay effect.

Moreover, the present invention can provide the active component array substrate 400 with more than two types of storage capacitors without requiring additional process steps. In addition, the present invention can provide multiple types of storage capacitors without affecting the aperture ratio.

### The Second Embodiment

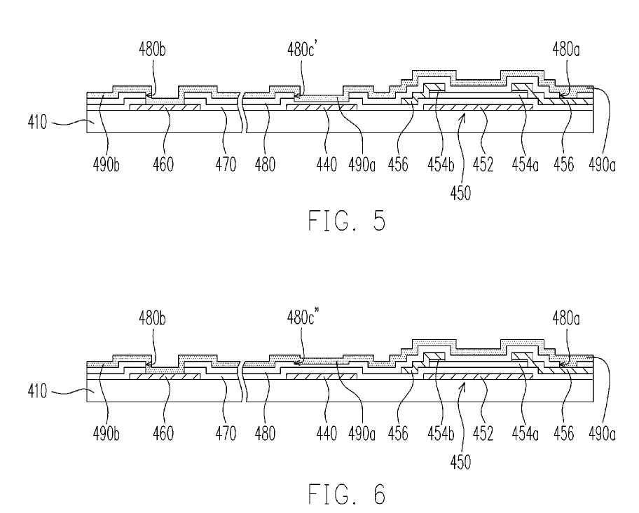

FIG. 5 is a schematic view of the active component array substrate according to a second embodiment of the present invention. Referring to FIGS. 5 and 3G, the second embodiment is similar to the first embodiment except for the following difference. The depths of the recesses 480c′ above the common lines 440 is determined by adjusting the thickness of the patterned photoresist layer 320 above the common lines 440. For example, the thickness of the patterned photoresist layer 320 above the common lines 440 is changed by adjusting the transmittance of the partially transmissive area 310b of the half tone mask 310. Alternatively, the thickness of the patterned photoresist layer 320 above the common lines 440 can also be changed by changing the total thickness of the patterned photoresist layer 320 without changing the design of the half tone mask 310.

Referring to FIG. 5, after the contact windows 480a and 480b are formed, the minimum distance between the recesses 480c′ and the common lines 440 is less than the thickness of the first dielectric layer 470 in the active components 450. In other words, as the distance between the pixel electrodes 490a and the common lines 440 is short compared to that of the conventional arts, storage capacitors with larger capacitance can be fabricated according to this embodiment without requiring any additional masks. Similarly, the capacitance of storage capacitors on each of the pixel regions 410a on the same scan line 420 gradually become high from the signal input end of the scan line 420 to the other end.

### The Third Embodiment

FIG. 6 is a schematic view of the active component array substrate according to a third embodiment of the present invention. Referring to FIG. 6, the third embodiment is similar to the first embodiment except for the following difference. The depths of the recesses 480c″ above the common lines 440 are determined by adjusting the thickness of the patterned photoresist layer 320 above the common lines 440. For example, the thickness of the patterned photoresist layer 320 above the common lines 440 is changed by adjusting the transmittance of the partially transmissive area 310b of the half tone mask 310. Alternatively, the thickness of the patterned photoresist layer 320 above the common lines 440 can also be changed by changing the total thickness of the patterned photoresist layer 320 without changing the design of the half tone mask 310.

Referring to FIG. 6, after the contact windows 480a and 480b are formed, the minimum distance between the recesses 480c″ and the common lines 440 is greater than the thickness of the first dielectric layer 470 in the active components 450. In other words, as the distance between the pixel electrodes and the common lines is short compared to that of the conventional arts, storage capacitors with larger capacitance can be fabricated according to the embodiment without requiring any addition masks. Similarly, the capacitance of storage capacitors on each of the pixel regions 410a on the same scan line 420 also gradually become high the signal input end of the scan line 420 to the other end.

Accordingly, the active component array substrate and the method for fabricating the same according to the present invention include at least the following advantages.

1. Compared to the conventional arts, the present invention employs the half tone mask to simultaneously form the contact windows and the recesses, and the pixel electrodes cover the recesses. Therefore, more than two types of storage capacitors can be formed on the same substrate by adjusting the depths of the recesses or the overlapping areas of the recesses and the pixel electrodes, such that the RC delay effect of large size panels is reduced or eliminated.

2. The storage capacitance value on a unit area is increased without requiring any additional masks.

3. The storage capacitors with a higher storage capacitance value can be formed without changing the aperture ratio.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for fabricating an active component array substrate, comprising:
providing a substrate having a plurality of scan lines, a plurality of data lines, a plurality of active components, a plurality of common lines, a first dielectric layer, and a second dielectric layer formed thereon, wherein the scan lines and the data lines define a plurality of pixel regions on the substrate, the common lines are arranged on the substrate, each of the active components is controlled by the corresponding scan line and the data line respectively, the first dielectric layer extends from each active component to above the pixel regions, and the second dielectric layer covers the scan lines, the data lines, the common lines, the active components and the first dielectric layer;
removing a portion of the second dielectric layer by using a half tone mask to form a plurality of contact windows and a recess over the common line on a portion of each pixel region; and
forming a pixel electrode over each of the pixel regions, wherein the pixel electrode is coupled to the common line to form a storage capacitor and each of the pixel electrodes is electrically connected to the active component via the corresponding contact window, wherein the storage capacitors are of more than two different types.

2. The method for fabricating the active component array substrate as claimed in claim 1, wherein the overlapping area of the recess and the common line above each pixel region is gradually reduced from one end of the common lines to another end.

3. The method for fabricating the active component array substrate as claimed in claim 1, wherein each of the common lines has a plurality of branches extending from the edges of two sides and are parallel to the data lines.

4. The method for fabricating the active component array substrate as claimed in claim 1, wherein the step of forming the contact windows and the recess comprises:
forming a patterned photoresist layer on the second dielectric layer by using the half tone mask;
removing a portion of the second dielectric layer using the patterned photoresist layer as the mask to form the contact windows and the recess over a portion of the common lines; and
removing the patterned photoresist layer.

5. The method for fabricating the active component array substrate as claimed in claim 4, wherein the step of forming the recess comprises removing a portion of the thickness of the second dielectric layer over a portion of the common lines.

6. The method for fabricating the active component array substrate as claimed in claim 4, wherein the step of forming the recess comprises completely removing the second dielectric layer over a portion of the common lines.

7. The method for fabricating the active component array substrate as claimed in claim 4, wherein the step of forming the recess comprises completely removing the second dielectric layer over a portion of the common lines and removing a portion of the thickness of the first dielectric layer.

8. An active component array substrate, fabricated with the method for fabricating an active component array substrate of claim 1, the active component array substrate comprising:
a substrate;
a plurality of scan lines, arranged on the substrate;
a plurality of data lines, arranged on the substrate, wherein the scan lines and the data lines define a plurality of pixel regions on the substrate;
a plurality of common lines, arranged on the substrate, wherein the common lines and the scan lines are alternately arranged on the substrate;
a plurality of active components, arranged on the pixel regions respectively, and each of the active components is controlled by the corresponding scan line and the data line;
a plurality of pixel electrodes, respectively arranged on the pixel regions, wherein each of the pixel electrodes is electrically connected to the corresponding active component and each of the pixel electrodes is coupled to the corresponding common line to form a storage capacitor;
a first dielectric layer, extending from the each of the active components to below the pixel electrodes; and
a second dielectric layer, covering the active components and extending from above the active components to below the pixel regions, wherein the second dielectric layer has a plurality of recesses over a portion of the common lines,
wherein the storage capacitors are of more than two types, and a minimum distance between each of the recesses and the common line is less than a total thickness of the first dielectric layer and the second dielectric layer in the corresponding active component.

9. The active component array substrate as claimed in claim 8, wherein the overlapping area of the recess and the common line above each pixel region is gradually reduced from one end of the common lines to another end.

10. The active component array substrate as claimed in claim 8, wherein each of the common lines has a plurality of branches extending outward from the edges of two sides and being parallel to the data lines.

11. The active component array substrate as claimed in claim 8, wherein a minimum distance between the recesses and the common line is greater than a thickness of the dielectric layer in the active component.

12. The active component array substrate as claimed in claim 8, wherein a minimum distance between the recesses and the common line is equal to a thickness of the dielectric layer in the active component.

13. The active component array substrate as claimed in claim 8, wherein a minimum distance between the recesses and the common line is less than a thickness of the dielectric layer in the active component.
